(19) United States
(12) Patent Application Publication
(10) Pub. No.: US 2024/0231321 A1
(43) Pub. Date: Jul. 11, 2024

(54) NUMERICAL CONTROL DEVICE AND COMPUTER-READABLE STORAGE MEDIUM

(71) Applicant: Fanuc Corporation, Minamitsuru-gun, Yamanashi (JP)

(72) Inventors: Kouhei Saitou, Minamitsuru-gun, Yamanashi (JP); Takenori Ono, Minamitsuru-gun, Yamanashi (JP)

(73) Assignee: Fanuc Corporation, Minamitsuru-gun, Yamanashi (JP)

(21) Appl. No.: 18/289,175

(22) PCT Filed: May 17, 2021
(86) PCT No.: PCT/JP2021/018641

§ 371 Date: Nov. 1, 2023

(51) Int. Cl. G05B 19/4155; G05B 19/4063

(52) U.S. Cl. CPC G05B 19/4155; G05B 19/4063; G05B 2219/35386

(57) ABSTRACT

A numerical control device includes a look-ahead analysis unit which sequentially looks ahead and analyzes a processing program; a control unit which controls a machine; a condition data storage unit which stores condition data including an analysis suppression condition specifying a look-ahead suppression condition and an analysis restart condition corresponding to the analysis suppression condition; an analysis suppression processing unit which suppresses analysis by the look-ahead analysis unit, when the analysis suppression condition is satisfied; an analysis restart processing unit which restarts the lookahead and the analysis when the control state of the machine satisfies the analysis restart condition while the analysis by the look-ahead analysis unit is suppressed; and a speculation analysis unit which executes speculative analysis, wherein when look-ahead is resumed, the result of speculative analysis by the speculation analysis unit is used.

### CROSS REFERENCE TO RELATED APPLICATIONS

This is the U.S. National Phase application of PCT/JP2021/018641, filed May 17, 2021, the disclosure of this application being incorporated herein by reference in its entirety for all purposes.

### FIELD OF THE INVENTION

The present invention relates to a numerical controller and a computer-readable storage medium.

### BACKGROUND OF THE INVENTION

A numerical controller reads blocks from a machining program and analyzes the read blocks so as to store pieces of data as the analysis result in a queue (FIFO (first in first out) memory). Then, the numerical controller sequentially reads the data stored in the queue to conduct control processing on a machine based on the read data. When the queue becomes empty of the data, the control processing on the machine is stopped until further pieces of data are stored. Thus, the numerical controller conducts the analysis processing by looking ahead a plurality of blocks from the machining program.

The machining program contains a macroinstruction, in addition to instructions for controlling a machine operation, such as axis movement instructions and auxiliary instructions. The macroinstruction includes an instruction for acquiring a signal value concerning a control state of the machine as a macro variable and an instruction, such as branch instruction or loop instruction, that changes an execution flow of the machining program according to the control state of the machine during execution. The analysis results of these instructions change depending on the control state of the machine. Thus, the execution by a look-ahead processing may cause an erroneous operation. In order to address such a problem, a technique has been put forth that enables the restriction and the resumption of the look-ahead process as needed basis (e.g., Patent Literature 1).

### PATENT LITERATURE

[Patent Literature 1] Japanese Patent Laid-Open Publication No. 2008-040542

### SUMMARY OF THE INVENTION

Excessive restriction of the look-ahead processing leads to the decrease in the efficiency of the machining program execution. It is therefore desired that the restriction and resumption of the look-ahead processing is conducted at an appropriate timing to the extent that erroneous execution of useless macroinstructions is restricted to some extent.

A numerical controller according to the present disclosure can arbitrarily set analysis restriction conditions with respect to any address instruction and any macro variable instruction. In addition to that, the numerical controller can arbitrarily set an analysis resumption condition that corresponds to each analysis restriction condition. In this way, the restriction/resumption of the look-ahead processing can be performed at the appropriate timing to thereby solve the above problem.

One aspect of the present disclosure is a numerical controller for controlling a machine based on a machining program, that includes: a look-ahead analysis unit that sequentially looks ahead and analyzes blocks in the machining program; a control unit that controls the machine based on a result of the analysis conducted by the look-ahead analysis unit; a condition data storage unit that stores condition data including an analysis restriction condition for specifying a look-ahead restriction condition and an analysis resumption condition corresponding to the analysis restriction condition for an arbitrary instruction; an analysis restriction processing unit that restricts the analysis by the look-ahead analysis unit when the analysis restriction condition included in the condition data is satisfied; an analysis resumption processing unit that monitors a state of control on the numerical controller and the machine during the restriction of the analysis by the look-ahead analysis unit, and when the state of control being monitored satisfies the analysis resumption condition included in the condition data, allows the look-ahead analysis unit to resume the analysis; and a speculation analysis unit that conducts speculative analysis on the blocks in the machining program when the analysis by the look-ahead analysis unit is restricted, wherein the look-ahead analysis unit resumes the analysis on the blocks by using a result of the speculative analysis by the speculation analysis unit.

Another aspect of the present disclosure is a computer-readable storage medium for storing a program that enables a numerical controller for controlling a machine based on a machining program to act as: a look-ahead analysis unit that sequentially looks ahead and analyzes blocks in the machining program; a control unit that controls the machine based on a result of the analysis conducted by the look-ahead analysis unit; a condition data storage unit that stores condition data including an analysis restriction condition for specifying a look-ahead restriction condition and an analysis resumption condition corresponding to the analysis restriction condition for an arbitrary instruction; an analysis restriction processing unit that restricts the analysis by the look-ahead analysis unit when the analysis restriction condition included in the condition data is satisfied; an analysis resumption processing unit that monitors a state of control on the numerical controller and the machine during the restriction of the analysis by the look-ahead analysis unit, and when the state of control being monitored satisfies the analysis resumption condition included in the condition data, allows the look-ahead analysis unit to resume the analysis; and a speculation analysis unit that conducts speculative analysis on the blocks in the machining program when the analysis by the look-ahead analysis unit is restricted, wherein when the analysis by the look-ahead analysis unit is resumed, a result of the speculative analysis by the speculation analysis unit is used to resume the analysis on the blocks.

One aspect of the invention enables the arbitrary setting of condition data for restricting and resuming the look-ahead processing with respect to any address instruction and any macroinstruction, and thus an analysis can be carried out on various instructions at an appropriate timing. Consequently, a cycle time may be shortened.

### BRIEF DESCRIPTION OF THE DRAWINGS

FIG. 1 is a hardware configuration diagram of a numerical controller;

FIG. 2 is a block diagram showing the functions of the numerical controller;

FIG. 3 shows an example of a machining program;

FIG. 4 shows another example of the machining program; and

FIG. 5 is a flowchart showing a schematic operational example of the numerical controller.

### DETAILED DESCRIPTION OF EMBODIMENTS OF THE INVENTION

A description about an embodiment of the present invention will be made with reference to the accompanying drawings.

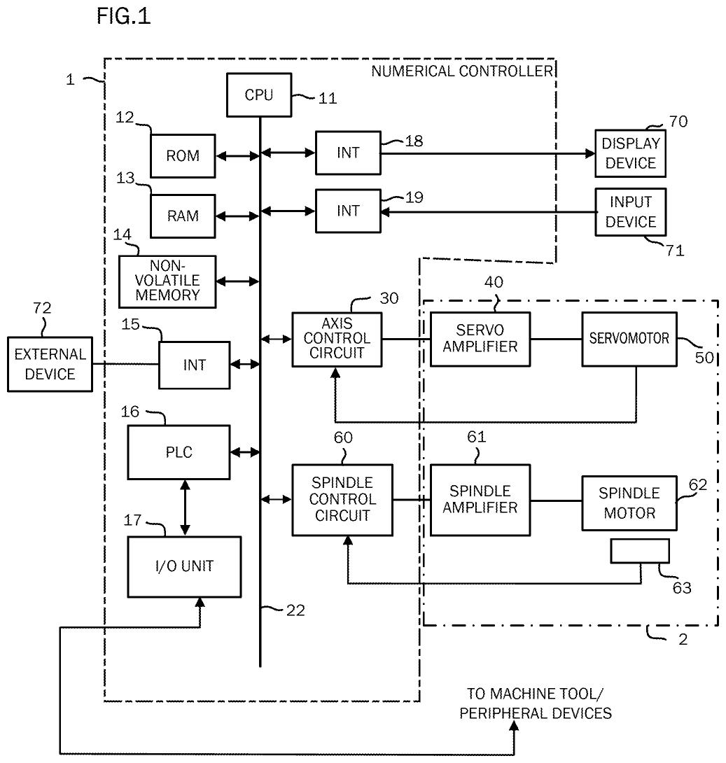

FIG. 1 is a schematic hardware configuration diagram showing a main part of a diagnosis device according to an embodiment of the invention. A numerical controller 1 of the invention can be implemented as a controller for controlling a machine tool 2 based on a machining program, for instance.

The numerical controller 1 according to the illustrative embodiment includes a central processing unit (CPU) 11, the CPU 11 being a processor for controlling the entire numerical controller 1. The CPU 11 is configured to read a system program stored in a read-only memory (ROM) 12 via a bus 22 to thereby control the entire numerical controller 1 in accordance with the system program. A random-access memory (RAM) 13 is configured to temporarily store temporary computation data and pieces of data to be displayed, as well as various pieces of data input by an external device.

A non-volatile memory 14 consists of a memory, solid state drive (SSD) or similar which is, for example, backed up by a battery, not shown. In the non-volatile memory 14, a state of storage of data written therein is retained even when a power source of the numerical controller 1 is turned off. The non-volatile memory 14 is configured to store, for example, pieces of data and machining programs read from an external device 72 via an interface 15, pieces of data and machining programs input via an input device 71, and pieces of data acquired from the machine tool 2. The pieces of data and the machining programs stored in the non-volatile memory 14 may be loaded into the RAM 13 when executed/used. Furthermore, the ROM 12 is configured to store beforehand various system programs, such as known analysis program.

The interface 15 is for connecting the CPU 11 of the numerical controller 1 to the external device 72, such as USB device. For example, machining programs, various parameters and others to be used for the control on the machine tool 2 can be read from the external device 72. In addition to that, machining programs, various parameters and others processed in the numerical controller 1 can be stored in external storing means, not shown, via the external device 72.

A programmable logic controller (PLC) 16 is a sequence program installed in the numerical controller 1 and is configured to output a signal to the machine tool 2 and its peripheral devices (e.g., actuators such as tool exchange device and robot, sensors attached to the machine tool 2) through an I/O unit 17 to control the machine tool and the peripheral devices. Furthermore, the PLC 16 receives signals from switches of a control panel disposed on a main body of an industrial machine and peripheral devices and supplies these signals to the CPU 11 after conducting necessary signal processing on the signals.

A display device 70 is configured to display various data read in the memory and pieces of data obtained by executing a machining program, system program or others, which are output via an interface 18, by way of example. In addition, the input device 71, which is form by a keyboard, a pointing device and others, is configured to transfer commands in accordance with an operation made by an operator, pieces of data and others to the CPU 11 via an interface 19.

An axis control circuit 30 for controlling an axis included in the machine tool 2 is configured to receive an amount of control instructions for the axis from the CPU 11 and output the instructions to a servo amplifier 40. The servo amplifier 40 is configured to receive the instructions to drive a servomotor 50 that moves a drive unit included in the machine tool 2 along the axis. The servomotor 50 for the axis incorporates a position/speed detector to feed back a position/speed feedback signal output from the position/speed detector to the axis control circuit 30, thereby performing feedback control for a position and speed. Although the hardware configuration diagram in FIG. 1 shows one axis control circuit 30, one servo amplifier 40 and one servomotor 50, these components are actually provided to the number of axes included in the machine tool 2 to be controlled. For example, in a case of controlling a common machine tool 2, three sets of the axis control circuit 30, the servo amplifier 40 and the servomotor 50 are provided for relatively moving a spindle to which a tool is attached and a workpiece in linear three axes directions (X axis, Y axis and Z axis).

A spindle control circuit 60 is configured to receive a spindle rotation instruction to output a spindle speed signal to a spindle amplifier 61. The spindle amplifier 61 is configured to receive the spindle speed signal to rotate a spindle motor 62 of the machine tool 2 at an instructed rotational speed, so as to drive the tool. To the spindle motor 62, a position coder 63 is coupled such that the position coder 63 is synchronized with the rotation of the spindle to thereby output a feedback pulse, and the feedback pulse is read by the CPU 11. Although the hardware configuration diagram in FIG. 1 shows one spindle control circuit 60, one spindle amplifier 61 and one spindle motor 62, these components are actually provided to the number of spindles included in the machine tool 2 to be controlled. For example, in a case of controlling a common machine tool 2 that has multiple systems, a plurality of the spindle control circuits 60, the spindle amplifiers 61 and the spindle motors 62 are provided because the machine tool has a spindle for attaching a tool for each system.

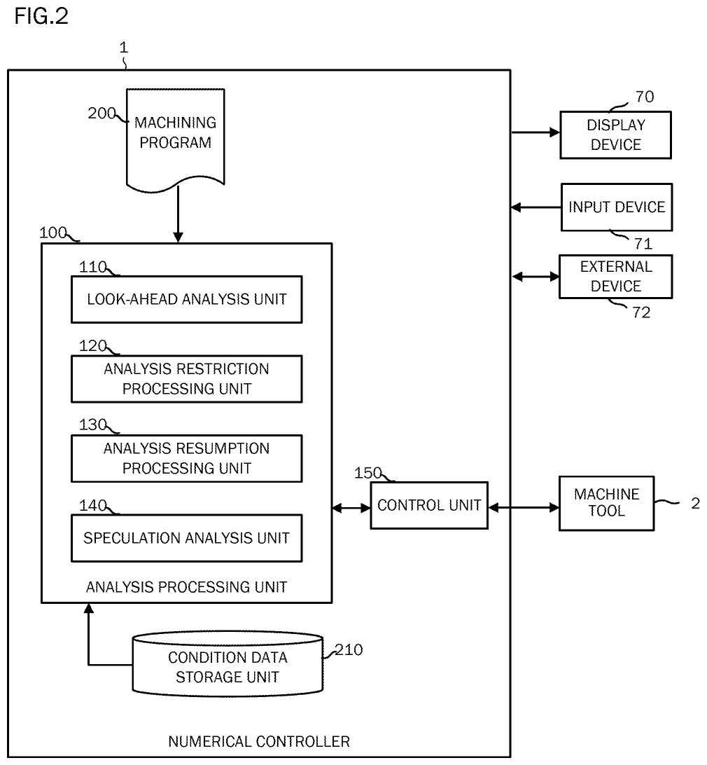

FIG. 2 shows functions of the numerical controller 1 according to a first embodiment of the invention as a schematic block diagram. The functions of the numerical controller 1 of the illustrative embodiment are implemented in such a way that the CPU 11 included in the numerical controller 1 executes a system program to control an operation of each unit of the numerical controller 1.

The numerical controller 1 of the illustrative embodiment includes an analysis processing unit 100 and a control unit 150. In addition to that, the RAM 13 or the non-volatile memory 14 of the numerical controller 1 stores beforehand a machining program 200 for controlling the machine tool 2, and a condition data storage unit 210 is prepared in advance that is an area for storing condition data that includes an analysis restriction condition and a corresponding analysis resumption condition.

The analysis processing unit 100 is configured to read and analyze a machining program, and then store analysis resultant data in a queue (FIFO memory), not shown. The pieces of data stored in the queue are sequentially read by the control unit 150 to use the data for controlling the machine tool 2. The analysis processing unit 100 includes a look-ahead analysis unit 110, an analysis restriction processing unit 120, an analysis resumption processing unit 130 and a speculation analysis unit 140.

The look-ahead analysis unit 110 is configured to look ahead a block in the machining program 200. The look-ahead block is stored in a buffer provided to the RAM 13, for instance. The buffer may store multiple blocks. The look-ahead analysis unit 110 then analyzes the look-ahead blocks in order. The analysis processing conducted by the look-ahead analysis unit 110 produces a movement control instruction for the servomotor 50 that drives axes of the machine tool 2, for example, when the look-ahead block gives an instruction to advance the axis. In addition to that, when the look-ahead block gives an instruction to rotate the spindle, for example, a rotation control instruction for the spindle is produced. The control instruction produced through the analysis by the look-ahead analysis unit 110 is output to the control unit 150 via the queue, not shown. When the analysis restriction processing unit 120 issues a look-ahead restriction instruction, the look-ahead analysis unit 110 suspends the look-ahead and the analysis of the blocks in the machining program 200. Furthermore, when the analysis resumption processing unit 130 issues a look-ahead resumption instruction, the look-ahead analysis unit 110 resumes the suspended look-ahead and the analysis of the blocks in the machining program 200.

The analysis restriction processing unit 120 is configured to refer to an analysis restriction condition included in the condition data stored in the condition data storage unit 210. Then, when the referred analysis restriction condition is satisfied, the analysis restriction processing unit 120 instructs the look-ahead analysis unit 110 to suspend the look-ahead and the analysis. The analysis restriction processing unit 120 refers to the buffer in which the look-ahead blocks of the machining program are stored by the look-ahead analysis unit 110. The analysis restriction processing unit 120 in turn conducts a preliminary analysis on a block (N+1 block or later one) posterior to a block (N block) currently under analysis by the look-ahead analysis unit 110. When the analysis restriction condition is satisfied in the concerned block, the processing unit 120 then instructs the look-ahead analysis unit 110 to restricts the analysis on the next block or later one (N+1 block or later one).

On the other hand, the analysis resumption processing unit 130 monitors the control state of the machine tool while the look-ahead and the analysis is suspended by the analysis restriction processing unit 120. A monitoring object includes a calculation status of coordinate data and data indicating an amount of movement for each control cycle in the control unit 150, data related to the state of the machine fed back from the machine tool 2, and the states of signals from the peripheral devices, by way of example. In a case where an analysis resumption condition is satisfied that corresponds to the analysis restriction condition, which is a cause of the restriction of the current look-ahead and analysis, the analysis resumption processing unit 130 instructs the look-ahead analysis unit 110 to resume the look-ahead and the analysis.

The condition data storage unit 210 stores beforehand condition data that includes an analysis restriction condition and at least one analysis resumption condition corresponding to the analysis restriction condition. The analysis restriction condition included in the condition data defines a condition for restricting the look-ahead and the analysis by the look-ahead analysis unit 110. The analysis restriction condition includes, for example, a condition related to the look-ahead of a predefined instruction or the look-ahead of instruction types included in a block in the machining program. The analysis resumption condition included in the condition data defines a condition for resuming the look-ahead and the analysis performed by the look-ahead analysis unit 110. The analysis resumption condition includes, for instance, a status of the control processing of the numerical controller (e.g., mode of each function, alarm state, program instruction value information, movement path information, macro variable) and the control state such as a machine control state (e.g., coordinate value, axis position, speed, number of rotations of the spindle, acceleration, signal, feedback information of a motor spindle). The analysis restriction condition and the corresponding analysis resumption condition included in the condition data are created by the developer of the numerical controller, a machine maker, a machine user and the like.

An example of the condition data will now be presented. For example, it is assumed that “execution of an instruction for referring to #5041” is defined as an analysis restriction condition included in condition data C1. The number “#5041” is a macro variable instruction for referring to the current coordinate value of an X-axis. With respect to this analysis restriction condition, “start the execution of a block next to a block that issues an instruction for moving the X-axis in the last place, which is the instruction prior to the instruction for referring to #5041” is defined as an analysis resumption condition. Furthermore, “completion of generation of pulse data in the block that instructs to move the X-axis in the last place, which is the instruction before the instruction for referring to #5041” as another analysis resumption condition.

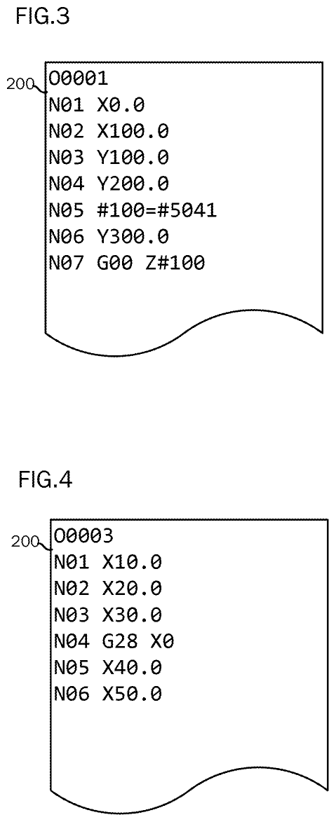

These pieces of condition data are stored in the condition data storage unit 210, and the numerical controller 1 executes the machining program 200 illustrated in FIG. 3. The look-ahead analysis unit 110 sequentially looks ahead the machining program 200 to conduct analysis. The analysis restriction processing unit 120 then conducts a preliminary analysis on a macro instruction “#100=#5041 ” in block N05, so as to suspend the look-ahead and the analysis by the look-ahead analysis unit 110 on a block subsequent to the block of the macro instruction “#5041” until a coordinate to which the X-axis should be moved according to the block instructing to move the X-axis in the last place (block N02), which is an instruction before the macro instruction, is determined. When the coordinate of the X-axis to be moved according to the block instructing to move the X-axis in the last place is determined, the look-ahead analysis unit 110 resumes the look-ahead and the analysis.

Another example of the condition data will be presented. For example, it is assumed that “execution of an instruction G28” is defined as an analysis restriction condition included in condition data C2. The instruction G28 is a control instruction to internally produce a cycle instruction for returning to the original position via a designated midpoint coordinate to control the machine tool 2 to be controlled according to the produced cycle instruction. With respect to this analysis restriction condition, “moving to the midpoint coordinate designated by the instruction G28” is defined as an analysis resumption condition. Furthermore, as another analysis resumption condition, “completion of a path computation in the first cycle designated by the instruction G28” can be defined.

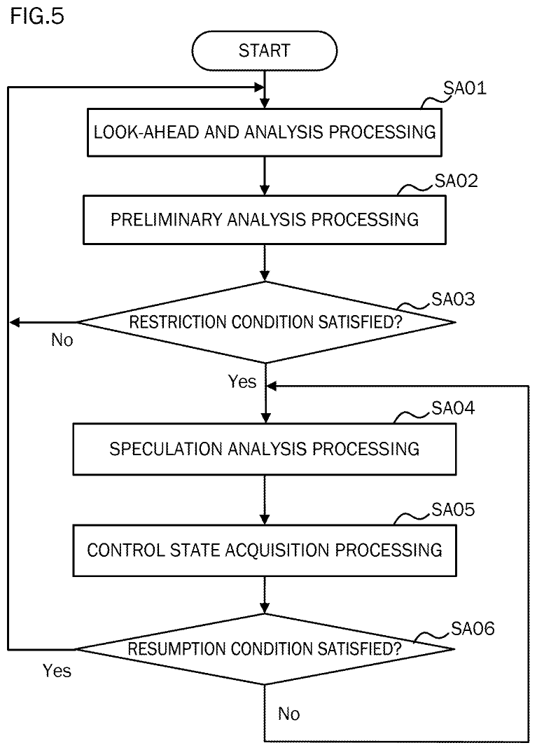

These pieces of condition data are stored in the condition data storage unit 210, and the numerical controller 1 executes the machining program 200 illustrated in FIG. 4. The look-ahead analysis unit 110 sequentially looks ahead the machining program 200 to conduct analysis. The analysis restriction processing unit 120 then conducts a preliminary analysis on the instruction “G28” in a block N04, so as to suspend the look-ahead and the analysis by the look-ahead analysis unit 110 on a block subsequent to the block of the instruction “G28” (subsequent to the instruction for returning to the original point after the midpoint coordinate in the cycle instruction produced by the instruction G28) until a destination coordinate at the midpoint designated by this instruction is determined. When the destination coordinate at the midpoint instructed according to the instruction G28 is determined, the look-ahead analysis unit 110 resumes the look-ahead and the analysis.

In a case where the look-ahead and the analysis by the look-ahead analysis unit 110 are suspended, the speculation analysis unit 140 conducts a speculative analysis on a subsequent unanalyzed block in the machining program. The speculative analysis by the speculation analysis unit 140 is conducted for a block composed of an instruction that is not affected by a result of an analysis resumption condition corresponding to an analysis restriction condition, which is a cause of the restriction of the current look-ahead and the analysis. For example, as with the example of the condition data C1, only the condition related to the X-axis movement is defined as the look-ahead and analysis resumption condition. In the case where the analysis restriction processing unit 120 is given an instruction to the look-ahead analysis unit 110 restrict the look-ahead and the analysis after the “#100=#5041 ”, when there is an moving instruction to move an axis other than the X-axis, such as Y-axis or Z-axis, after the macro instruction “#5041”, the speculation analysis unit 140 conducts a speculative analysis on a block that includes the concerned instruction. More specifically, as to a block N06, this instruction is for moving the Y-axis only and thus is not affected by the change in the X-axis, so that the speculative analysis can be conducted. By contrast, as to a block N07, this instruction is for referring to the macro variable #100 to which the coordinate value of the X-axis is assigned, so that the analysis cannot be made until the position of the X-axis is determined. Thus, this block is not an object of the speculative analysis. However, even if blocks that cannot be subjected to the analysis are found during the speculative analysis, when a block composed of an instruction that is not affected by the result of the analysis resumption condition is found afterward, the speculation analysis unit 140 may include the concerned block in the speculative analysis. The result of the speculative analysis acquired by the speculation analysis unit 140 is temporarily stored in the RAM 13 or the non-volatile memory 14.

When the look-ahead and the analysis is resumed by the look-ahead analysis unit 110 according to the instruction given by the analysis resumption processing unit 130, the look-ahead analysis unit 110 refers to whether there is a result of analysis conducted by the speculation analysis unit 140. When there is the result of analysis conducted by the speculation analysis unit 140, the look-ahead analysis unit 110 uses the analysis result for the analysis processing.

The control unit 150 is configured to control the operations of the machine tool 2 and its peripheral devices based on the analysis result of the machining program 200 output from the analysis processing unit 100. The control unit 150 computes data about the axis movement (e.g., coordinate data, data indicating the amount of movement in each control cycle) based on a control instruction for moving each axis of the machine tool 2, by way of example. Then, the control unit 150 controls the servomotor 50 based on the computed data. In addition to that, the control unit 150 computes, for instance, data about the rotation of the spindle of the machine tool 2 based on a control instruction for rotating the spindle. Then, the control unit 150 controls the spindle motor 62 based on the computed data. Furthermore, the control unit 150 computes, for instance, certain signals for operating the peripheral devices based on instructions for operating the peripheral devices of the machine tool 2, and outputs the signals to the PLC 16. On the other hand, the control unit 150 acquires the statuses of the servomotor 50 and the spindle motor 62 (e.g., current values, positions, speeds, acceleration, torques, temperatures of the motors) as feedback values, and stores the values as data indicating the control state in the RAM 13 or the non-volatile memory 14.

FIG. 5 is a flowchart schematically showing an operation of the analysis processing unit 100 of the numerical controller 1 according to the embodiment.

When the machining program 200 is executed on the numerical controller 1, the look-ahead analysis unit 110 sequentially looks ahead the blocks in the machining program 200 into the buffer provided on the RAM 13. Then, the look-ahead analysis unit 110 conducts analysis on an instruction in each look-ahead block (Step SA01).

Concurrently with the processing carried out by the look-ahead analysis unit 110, the analysis restriction processing unit 120 conducts preliminarily analysis on each look-ahead block in the buffer that is posterior to the block being analyzed by the look-ahead analysis unit 110 (Step SA02). Then, on the basis of the result of the preliminarily analysis, the analysis restriction processing unit 120 determines whether or not the analysis restriction condition included in the condition data stored in the condition data storage unit 210 is satisfied (Step SA03). While the analysis restriction condition is not satisfied, the look-ahead and the analysis as well as the preliminarily analysis are repeated.

When the analysis restriction condition is satisfied, the speculation analysis unit 140 identifies a block that includes an instruction that can be subjected to the speculative analysis based on an analysis resumption condition corresponding to the satisfied analysis restriction condition and conducts the speculative analysis on the identified block (Step SA04). The analysis result is temporarily stored in the RAM 13 or the non-volatile memory 14.

The analysis resumption processing unit 130 monitors a control state, such as a state of control processing on the numerical controller 1 or a state of controlling a machine, while the analysis processing is restricted (Step SA05). Then, the analysis resumption processing unit 130 determines whether the control state being monitored satisfies the analysis resumption condition (Step SA06). When the analysis resumption condition is not satisfied, the monitoring on the control state is repeated. When the condition is satisfied, the analysis resumption processing unit 130 instructs the look-ahead analysis unit 110 to resume the look-ahead and the analysis.

The numerical controller 1 having the above-described configuration is capable of arbitrarily setting the condition data about the look-ahead restriction and the look-ahead resumption for any address instruction and any macro instruction, so as to be able to execute the analysis in the various instructions at an appropriate timing. It can eliminate unnecessary analysis restriction, and thereby the cycle time may be shortened. Furthermore, the speculative analysis can be made during restricting the analysis, so that the data thus obtained can be used when the analysis is resumed. Thus, the reduction of analysis information creation time for the blocks can be expected.

The embodiment of the present invention has been described as above, but the present invention is not limited thereto and thus can be implemented in various ways by modifying it appropriately.

For example, the above-described embodiment shows a case of executing the functions in succession, but the functions may be processed concurrently. For example, FIG. 5 shows that the speculative analysis process in Step SA04 and the analysis resumption processes in Steps SA05 to SA06 are executed in order. However, a numerical controller with a multi-core processor capable of concurrent processing can be operated without any problem even when the above processes are assigned to various CPU cores to conduct concurrent processing.

### REFERENCE SIGNS LIST

1 Numerical controller
2 Machine Tool
11 CPU
12 ROM
13 RAM
14 Non-Volatile Memory
15, 18, 19 Interface
16 PLC
17 I/O Unit
22 Bus
Axis Control Circuit
Servo Amplifier
50 Servomotor
60 Spindle Control Circuit
61 Spindle Amplifier
62 Spindle Motor
63 Position Coder
70 Display Device
71 Input Device
72 External Device
100 Analysis Processing Unit
110 Look-Ahead Analysis Unit
120 Analysis Restriction Processing Unit
130 Analysis Resumption Processing Unit
140 Speculation Analysis Unit
150 Control Unit
200 Machining program
210 Condition Data Storage Unit

1. A numerical controller for controlling a machine based on a machining program, comprising:
a look-ahead analysis unit that sequentially looks ahead and analyzes blocks in the machining program;
a control unit that controls the machine based on a result of the analysis conducted by the look-ahead analysis unit;
a condition data storage unit that stores condition data including an analysis restriction condition for specifying a look-ahead restriction condition and an analysis resumption condition corresponding to the analysis restriction condition for an arbitrary instruction;
an analysis restriction processing unit that restricts the analysis by the look-ahead analysis unit when the analysis restriction condition included in the condition data is satisfied;
an analysis resumption processing unit that monitors a state of control on the numerical controller and the machine during the restriction of the analysis by the look-ahead analysis unit, and when the state of control being monitored satisfies the analysis resumption condition included in the condition data, allows the look-ahead analysis unit to resume the analysis; and
a speculation analysis unit that conducts speculative analysis on the blocks in the machining program when the analysis by the look-ahead analysis unit is restricted,
wherein the look-ahead analysis unit resumes the analysis on the blocks by using a result of the speculative analysis conducted by the speculation analysis unit.

2. The numerical controller according to claim 1, wherein the state of control on the numerical controller and the machine is at least one of a result of computation conducted by the control unit and data fed back from the machine.

3. The numerical controller according to claim 1, wherein the processing by the analysis resumption processing unit and the processing by the speculation analysis unit are conducted in succession or concurrently with each other.

4. A computer-readable storage medium storing a program that enables a numerical controller, which controls a machine based on a machining program, to act as:
a look-ahead analysis unit for sequentially looking ahead and analyzing blocks in the machining program;
a control unit for controlling the machine based on a result of the analysis conducted by the look-ahead analysis unit;
a condition data storage unit for storing condition data including an analysis restriction condition for specifying a look-ahead restriction condition and an analysis resumption condition corresponding to the analysis restriction condition for an arbitrary instruction;
an analysis restriction processing unit for restricting the analysis by the look-ahead analysis unit when the analysis restriction condition included in the condition data is satisfied;
an analysis resumption processing unit for monitoring a state of control on the numerical controller and the machine during the restriction of the analysis by the look-ahead analysis unit, and when the state of control being monitored satisfies the analysis resumption condition included in the condition data, allowing the look-ahead analysis unit to resume the analysis; and
a speculation analysis unit for conducting speculative analysis on the blocks in the machining program when the analysis by the look-ahead analysis unit is restricted,
wherein when the analysis by the look-ahead analysis unit is resumed, a result of the speculative analysis by the speculation analysis unit is used to resume the analysis on the blocks.
